(19) United States
(12) Patent Application Publication
(10) Pub. No.: US 2009/0009794 A1
(43) Pub. Date: Jan. 8, 2009

(54) Image processing apparatus capable of tracing printed image, image processing method executed in the image processing apparatus, and image processing program embodied on computer readable medium

(75) Inventors: Takeshi Morikawa, Takarazuka-shi (JP); Kei Shigehisa, Amagasaki-shi (JP); Takeshi Minami, Amagasaki-shi (JP); Nobuo Kamei, Amagasaki (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/987,651

(22) Filed: Dec. 3, 2007

(30) Foreign Application Priority Data
Jul. 2, 2007 (JP) 2007-173790

(51) Int. Cl. G06K 1/00; G06F 15/00

(52) U.S. Cl. 358/1.15; 358/1.13; 358/1.16

(57) ABSTRACT

In order to store a detailed history of outputting an image, MFP includes an image obtaining portion to obtain an image, an additional information obtaining portion to obtain additional information related to the obtained image, an embedding portion to generate an output image formed by adding the additional information to the obtained image, an output portion to output the obtained image, if additional information is not obtained, and to output the generated output image, if additional information is obtained, and a transmission portion to transmit a history of the obtained image being output to a server. The transmission portion transmits the additional information as a history together with the obtained image, if additional information is obtained, and transmits the obtained image as a history, if additional information is not obtained.

This application is based on Japanese Patent Application No. 2007-173790 filed with Japan Patent Office on Jul. 2, 2007, the entire content of which is hereby incorporated by reference.

### BACKGROUND OF THE INVENTION

1. Field of the Invention

The present invention relates to an image processing apparatus, an image processing method and an image processing program embodied on a computer readable medium, and more particularly to an image processing apparatus capable of tracing printed images, an image processing method executed in the image processing apparatus and an image processing program embodied on a computer readable medium.

2. Description of the Related Art

Recently, a multifunction apparatus called MFP (Multi Function Peripheral), including the functions of a scanner, a printer, a copier and a facsimile machine has emerged. A system is known in which this MFP stores images that have been printed into a server or the like to allow the history of the images being printed to be traced.

On the other hand, a technique of embedding information in image data using digital watermarking has been developed. For example, Japanese Laid-Open Patent Publication No. 2007-49440 discloses a technique of converting information to be embedded into a dot pattern and forming an image including the dot pattern combined with image data on a sheet of paper.

However, the information embedded in image data using digital watermarking may not be stored in a server. For example, some MFPs execute a process of embedding information in image data using digital watermarking, together with a process of printing. Such MFPs cannot transmit the image data having information embedded therein using digital watermarking to a server. Therefore, the information embedded in the image cannot be stored in the server. In addition, even if MFP can transmit image data having information embedded therein using digital watermarking to a server, the image data is often reduced or irreversibly compressed in order to reduce the amount of data when the image data is stored in the server. Reduction or irreversible compression of image data causes the information embedded in image data to be lost therefrom. Therefore, it is impossible to store the information embedded in image data using digital watermarking in a server.

Moreover, in a case where image data includes information that refers to another data such as URL, the data itself specified by the URL may be deleted after the image of the image data is formed on paper. In this case, it becomes impossible to specify the data specified by the URL included in the image from the image formed on paper based on the image data.

As described above, conventionally, although image data can be stored as history information in a server at a time when an image of the image data is formed on paper, information added to the image data cannot be incorporated in the history information.

### SUMMARY OF THE INVENTION

The present invention is made to solve the aforementioned problem. An object of the present invention is to provide an image processing apparatus which allows a detailed history of outputting an image to be stored.

Another object of the present invention is to provide an image processing method and an image processing program which allow a detailed history of outputting an image to be stored.

In order to achieve the aforementioned object, in accordance with an aspect of the present invention, an image processing apparatus includes: an image obtaining portion to obtain an image; an additional information obtaining portion to obtain additional information related to the obtained image; an output image generation portion to generate an output image formed by adding the obtained additional information to the obtained image; an output portion to output the obtained image, if the additional information is not obtained, and to output the generated output image, if the additional information is obtained; and a history storage portion to store a history of the obtained image being output. The history storage portion stores the additional information as a history together with the obtained image, if the additional information is obtained, and stores the obtained image as a history, if the additional information is not obtained.

In accordance with another aspect of the present invention, an image processing apparatus includes: an image obtaining portion to obtain an image; an output portion to output the obtained image; a location information extraction portion to extract location information indicating a location on a network from the obtained image; an additional information obtaining portion to obtain related data stored at a location specified by the extracted location information; and a history storage portion to store a history of the obtained image being output. If the related data is obtained from the additional information obtaining portion, the history storage portion stores the obtained related data together with the obtained image.

In accordance with a further aspect of the present invention, an image processing method includes the steps of obtaining an image; obtaining additional information related to the obtained image; generating an output image formed by adding the obtained additional information to the obtained image; outputting the obtained image, if the additional information is not obtained, and outputting the generated output image, if the additional information is obtained; and storing the additional information as a history together with the obtained image, if the additional information is obtained, and storing the obtained image as a history, if the additional information is not obtained.

In accordance with yet another aspect of the present invention, an image processing method includes the steps of: obtaining an image; outputting the obtained image; extracting location information indicating a location on a network from the obtained image; obtaining related data stored at a location specified by the extracted location information; and if the related data is not obtained, storing the obtained image, and, if the related data is obtained, storing the obtained related data together with the obtained image.

In accordance with a further aspect of the present invention, an image processing program is embodied on a computer readable medium for causing a computer to execute processing including the steps of: obtaining an image; obtaining additional information related to the obtained image; generating an output image formed by adding the obtained additional information to the obtained image; outputting the obtained image, if the additional information is not obtained, and outputting the generated output image, if the additional information is obtained; and storing the additional information as a history together with the obtained image, if the additional information is obtained, and storing the obtained image as a history, if the additional information is not obtained.

In accordance with a still further aspect of the present invention, an image processing program is embodied on a computer readable medium for causing a computer to execute processing including the steps of: obtaining an image; outputting the obtained image; extracting location information indicating a location on a network from the obtained image; obtaining related data stored at a location specified by the extracted location information; and if the related data is not obtained, storing the obtained image, and, if the related data is obtained, storing the obtained related data together with the obtained image.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an overall view schematically showing an image processing system in an embodiment of the present invention.

FIG. 2 is an external perspective view of MFP.

FIG. 3 is a block diagram showing an exemplary hardware configuration of MFP.

FIG. 4 is a first functional block diagram showing an overall function of CPU included in MFP.

FIG. 5 is a diagram showing an example of additional information.

FIG. 6A-FIG. 6D are diagrams showing an example of pattern image.

FIG. 7 is a second functional block diagram showing an overall function of CPU included in MFP.

FIG. 8 is a flowchart showing an exemplary flow of an output process.

FIG. 9 is a flowchart showing an exemplary flow of an additional information extraction process.

FIG. 10 is a flowchart showing an exemplary flow of an embedding process.

FIG. 11 is a flowchart showing an exemplary flow of a server transfer process.

FIG. 12 is a flowchart showing an exemplary flow of a restriction process.

FIG. 13 is a functional block diagram showing an overall function of CPU included in MFP in a modification.

FIG. 14 is a flowchart showing a flow of an output process in a modification.

### DESCRIPTION OF THE PREFERRED EMBODIMENTS

In the following, an embodiment of the present invention will be described with reference to the figures. Their designations and functions are also the same. Therefore, a detailed description thereof will not be repeated.

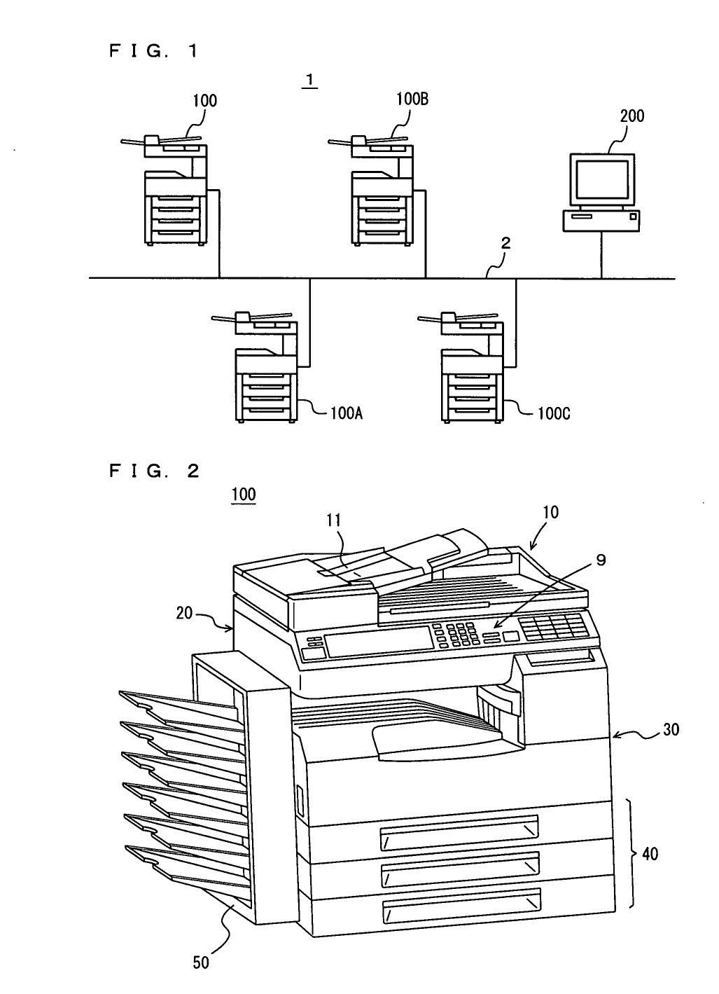

FIG. 1 is an overall view schematically showing an image processing system in an embodiment of the present invention. Referring to FIG. 1, an image processing system 1 includes Multi Function Peripherals (referred to as “MFP” hereinafter) 100, 100A, 100B, 100C as image formation apparatuses and a server 200, each connected to a network 2. Server 200 is a general computer.

Server 200 manages the histories of processes executed by each of MFPs 100, 100A, 100B, 100C. Therefore, each of MFPs 100, 100A, 100B, 100C transmits processed image data and process content thereof to server 200. At server 200, when image data and process content thereof are received from any of MFPs 100, 100A, 100B, 100C, they are stored in a nonvolatile storage device such as a hard disk drive (HDD) for each MFP that has transmitted them.

It is noted that although in the present embodiment, MFPs 100, 100A, 100B, 100C are described as an example of image formation apparatus, MFPs 100, 100A, 100B, 100C may be replaced by, for example, scanners, printers, facsimiles, personal computers, or the like as long as the apparatuses include the function of processing images. Network 2 is a local area network (LAN), whether wired or wireless. Network 2 is not limited to a LAN, or may be a wide area network (WAN), a public switched telephone network (PSTN), the Internet, or the like. Although one server 200 is used here by way of example, a plurality of servers may be used. In this case, MFPs 100, 100A, 100B, 100C transmit the processed image data and the process contents thereof to one or more of a plurality of servers.

Although the respective functions of MFP 100, 100A, 100B, 100C may differ, here, it is assumed that all have the same functions, and MFP 100 will be described as an example.

FIG. 2 is an external perspective view of MFP. Referring to FIG. 2, MFP 100 includes an automatic document feeder (ADF) 10, an image reading portion 20, an image formation portion 30, a paper-feeding portion 40, and a post-processing portion 50. ADF 10 conveys a document having a number of pages placed on a document plate, one by one in order, to image reading portion 20. Image reading portion 20 optically reads image information such as photographs, characters and pictures from the document to obtain image data.

Image formation portion 30 receives image data to form an image on a sheet of paper based on the image data. Image formation portion 30 forms color images using toner in four colors, namely, cyan, magenta, yellow and black. Image formation portion 30 also forms monochrome images using toner in one color of cyan, magenta, yellow and black. In addition, image formation portion 30 receives additional information together with image data to convert the additional information into a dot pattern and generate a combination image including an image of the dot pattern converted from the additional information and an image of the image data. Thus, the additional information is embedded in the image of image data as a digital watermark image. Then, the combination image is formed on paper.

Paper-feeding portion 40 stores sheets of paper and supplies the stored sheets one by one to image formation portion 30. Post-processing portion 50 discharges a sheet of paper having an image formed thereon. Post-processing portion 50 has a plurality of paper-discharge trays to allow recording sheets to be sorted and discharged. Post-processing portion 50 additionally includes a punched-hole processing portion and a stapling processing portion to allow a punched-hole process or a stapling process to be performed on the discharged recording sheet. MFP 100 includes an operation panel 9 on the upper surface thereof.

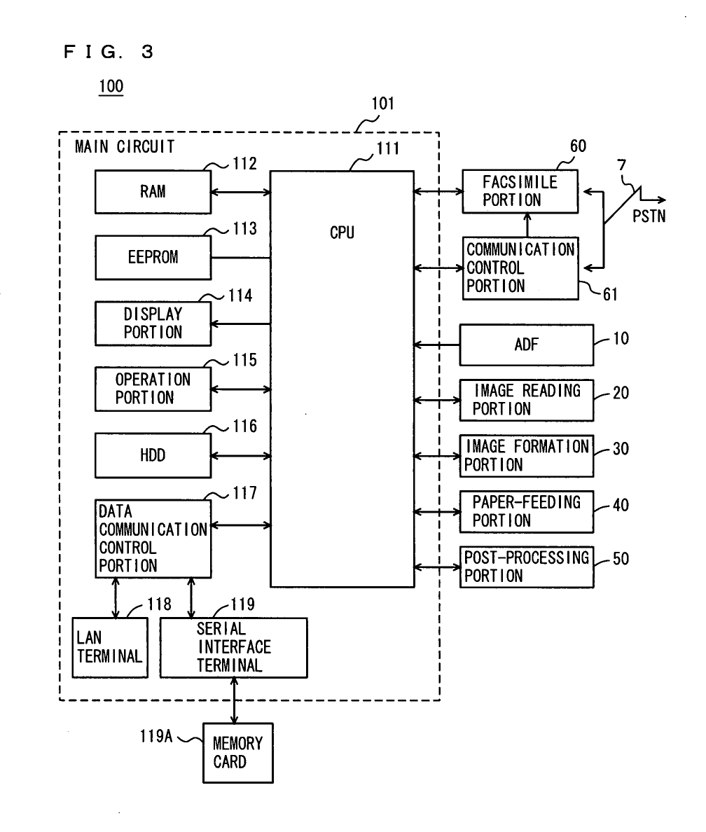

FIG. 3 is a block diagram showing an exemplary hardware configuration of MFP. With reference to FIG. 3, MFP 100 includes a main circuit 101 connected to a facsimile portion 60, a communication control portion 61, ADF 10, image reading portion 20, image formation portion 30, paper-feeding portion 40, and post-processing portion 50. Main circuit 101 includes a central processing unit (CPU) 111, a RAM (Random Access Memory) 112 used as a work area for CPU 111, an EEPROM (Electronically Erasable Programmable Read Only Memory) 113 for storing a program executed by CPU 111 and the like, a display portion 114, an operation portion 115, a hard disk drive (HDD) 116 as a mass storage device, and a data communication control portion 117. CPU 111 is connected to each of display portion 114, operation portion 115, HDD 116 and data communication control portion 117 to control main circuit 101 as a whole. CPU 111 is also connected to facsimile portion 60, communication control portion 61, ADF 10, image reading portion 20, image formation portion 30, paper-feeding portion 40, and post-processing portion 50 to control the entire MFP 100.

Display portion 114 is a display such as a liquid crystal display (LCD) or an organic ELD (Electro-Luminescence display) to display instruction menus for the user, information about the obtained image data, and the like. Operation portion 115 includes a plurality of keys and accepts inputs of a variety of instructions and data such as characters and numerals by the user's operations corresponding to keys. Operation portion 115 includes a touch-panel provided on display portion 114. Display portion 114 and operation portion 115 constitute operation panel 9.

Data communication control portion 117 has a LAN terminal 118 which is an interface for communications via a communication protocol such as TCP (Transmission Control Protocol) or FTP (File Transfer Protocol), and a serial communication interface terminal 119 for serial communications. Data communication control portion 117 transmits/receives data to/from external equipment connected to LAN terminal 118 or serial communication interface terminal 119, according to an instruction from CPU 111.

When a LAN cable for connecting to a network is connected to LAN terminal 118, data communication control portion 117 communicates with MFPs 100A, 100B, 100C and server 200 through LAN terminal 118.

CPU 111 controls data communication control portion 117 to read a program executed by CPU 111 from a memory card 119A and store the read program into RAM 112 for execution. It is noted that a recording medium storing a program executed by CPU 111 is not limited to memory card 119A and may be a medium such as a flexible disk, a cassette tape, an optical disk (CD-ROM (Compact Disc-Read Only Memory)/MO (Magnetic Optical Disc/MD (Mini Disc)/DVD (Digital Versatile Disc)), an IC card, an optical card, or a semiconductor memory such as a mask ROM, EPROM (Erasable Programmable ROM), or EEPROM (Electronically EPROM). Alternatively, CPU 111 may download a program from a computer connected to the Internet for storage into HDD 116, or a computer connected to the Internet may write a program into HDD 116 so that the program stored in HDD 116 is loaded into RAM 112 and executed by CPU 111. The program referred to herein includes not only a program directly executable by CPU 111 but also a source program, a compressed program, an encrypted program, and the like.

Communication control portion 61 is a modem for connecting CPU 111 to a PSTN (Public Switched Telephone Networks) 7. A telephone number in PSTN 7 is assigned to MFP 100 beforehand, and when a call is originated from a facsimile machine connected to PSTN 7 to the telephone number assigned to MFP 100, communication control portion 61 detects the call. Upon detection of the call, communication control portion 61 establishes a call to allow facsimile portion 60 to communicate.

Facsimile portion 60 is connected to PSTN 7 to transmit facsimile data to PSTN 7 or receive facsimile data from PSTN 7. Facsimile portion 60 converts the received facsimile data into print data that can be printed in image formation portion 30 and outputs the converted data to image formation portion 30. Accordingly, image formation portion 30 prints the facsimile data received from facsimile portion 60 on a recording sheet. In addition, facsimile portion 60 converts the data stored in HDD 116 into facsimile data and transmits the converted data to a facsimile machine connected to PSTN 7 or other MFPs. Thus, the data stored in HDD 116 can be output to a facsimile machine or other MFPs. In this manner, MFP 100 has a facsimile transmission/reception function.

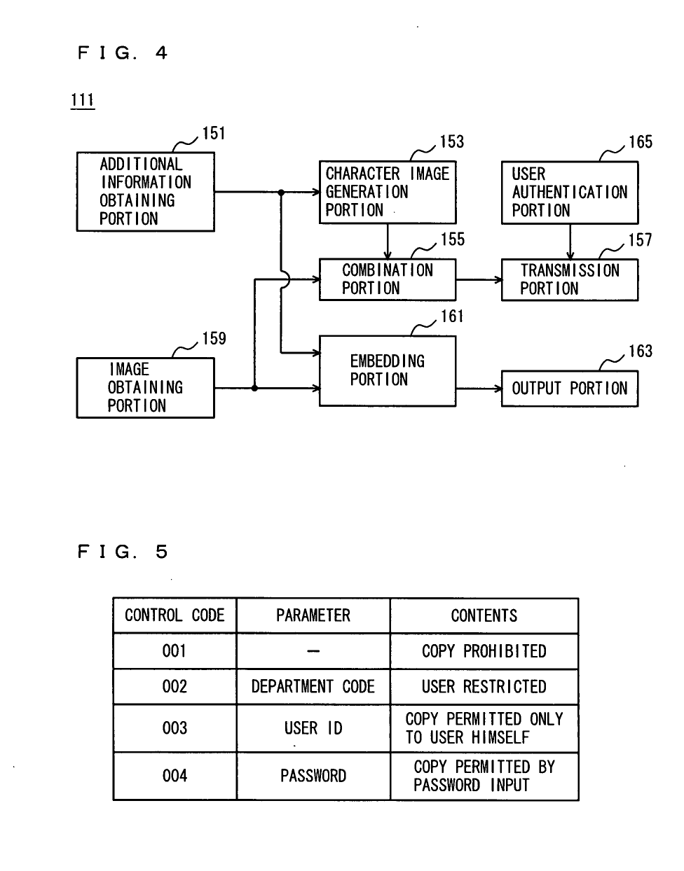

FIG. 4 is a first functional block diagram showing an overall function of CPU included in MFP. The functional block diagram shown in FIG. 4 shows the functions at a time when MFP 100 outputs an image. Referring to FIG. 4, CPU 111 includes an additional information obtaining portion 151 obtaining additional information, a character image generation portion 153 for generating a character image formed by converting the character of additional information into an image, an image obtaining portion 159 for obtaining an image, a combination portion 155 for generating a combination image formed by combining an image with a character image, an embedding portion 161 for electronically embedding additional information in an image, an output portion 163 for outputting an image, a transmission portion 157 for transmitting an image to server 200, and a user authentication portion 165 for authenticating a user.

Image obtaining portion 159 obtains an image and outputs the obtained image to combination portion 155 and embedding portion 161. The image obtained by image obtaining portion 159 will be referred to as an obtained image hereinafter. When a user operates operation portion 115 to input the process content of each of a scan job, a copy job, a FAX transmission job, and a document data transmission job, the read image output by image reading portion 20 reading an original document is input to image obtaining portion 159. A data transmission job includes different kinds of jobs with different transmission methods (protocols). Here, the data transmission job includes an FTP transmission job of transmitting an obtained image via FTP (File Transfer Protocol), an SMB transmission job of transmitting an obtained image via SMB (Server Message Block), and an email transmission job of transmitting an email with an obtained image attached thereto.

Furthermore, when a user operates operation portion 115 to input the process content of a BOX print job or a recorded image data transmission job, image obtaining portion 159 reads an image designated by the BOX print job or the data transmission job from images stored in HDD 116. The BOX print job is a job of forming an image stored in HDD 116 on paper.

In addition, when data communication control portion 117 receives a print job or a data storage job from MFPs 100A, 100B, 100C, server 200 or a personal computer connected through LAN terminal 118, image obtaining portion 159 obtains an image included in the print job or the data storage job received from data communication control portion 117. The data storage job is a job of storing an image included in the received data storage job into HDD 116. Still further, when facsimile portion 60 receives a FAX reception job from an external facsimile machine, image obtaining portion 159 obtains facsimile data (image) included in the FAX reception job.

User authentication portion 165 authenticates a user operating MFP 100. MFP 100 stores user data in which a user ID for identifying a user, a password, and a department code for identifying a department to which the user belongs are associated with each other. When a pair of a user ID and a password that is identical to a pair of a user ID and a password included in the user data is input to operation portion 115, user authentication portion 165 authenticates the user. If a user is authenticated, user authentication portion 165 outputs the user ID of the user to transmission portion 157.

When the process contents of a copy job and a BOX print job are input to operation portion 115, additional information obtaining portion 151 obtains additional information included in the process contents. In a case where a print job is received, additional information obtaining portion 151 obtains additional information included in the print job. In a case where facsimile data is received, additional information obtaining portion 151 obtains additional information included in the facsimile data. Additional information obtaining portion 151 outputs the obtained additional information to character image generation portion 153 and embedding portion 161.

Here, additional information will be described. Additional information is information related to an image. Here, it will be described by way of example that additional information is information for restricting copying of an image formed on paper.

FIG. 5 is a diagram showing an example of additional information. Referring to FIG. 5, the additional information includes a control code and a parameter. Here, the additional information with a control code “001” indicates prohibition of copying of an image, and nothing is set in the parameter. The additional information with a control code “002” indicates control of restricting a user who is permitted to copy to a range set in the parameter, and a department code is included in the parameter. The additional information with a control code “003” indicates control of restricting a user who is permitted to copy to a range set in the parameter, and a user ID is included in the parameter. The additional information with a control code “004” indicates control of permitting copying on condition that a password set in the parameter is input, and a password is included in the parameter.

Returning to FIG. 4, character image generation portion 153 converts additional information input from additional information obtaining portion 151 into an image of characters and generates a character image. Character image generation portion 153 outputs the character image to combination portion 155. When the character image is input from character image generation portion 153, combination portion 155 combines the character image with an obtained image input from image obtaining portion 159 and generates a combination image. Combination portion 155 outputs the combination image to transmission portion 157. When a character image is not input from character image generation portion 153, in other words, when additional information is not obtained in additional information obtaining portion 151, combination portion 155 outputs the obtained image input from image obtaining portion 159 to transmission portion 157.

Transmission portion 157 transmits a log to server 200. A log includes a combination image or an obtained image, the user ID of a user authenticated by user authentication portion 165, apparatus identification information for identifying MFP 100, a date and time, and a process content. At server 200, when a log is received from MFP 100, the log is recorded in a recording medium such as HDD. Therefore, by referring to the log stored in server 200, by whom, when, at which apparatus, which image, and with which process content is output can be specified. Since a combination image is an image formed by combining an image of characters of additional information with an obtained image, the additional information can be specified from the combination image.

In a case where additional information is input from additional information obtaining portion 151, embedding portion 161 embeds additional information input from additional information obtaining portion 151 in an obtained image input from image obtaining portion 159. Here, the image formed by embedding additional information in an obtained image is referred to as an embedding image. Specifically, embedding portion 161 converts the characters included in additional information into a dot pattern including a plurality of dots as predetermined corresponding to characters. Here, characters may be converted into a code associated therewith beforehand to be converted into a dot pattern corresponding to the code. Then, the dot pattern corresponding to the additional information is combined with the obtained image. The position where a dot pattern is arranged in an obtained image is preferably a position where information such as a background is not included in the obtained image. Embedding portion 161 outputs the embedding image having additional information embedded therein to output portion 163. Here, in the case where additional information is not input from additional information obtaining portion 151, embedding portion 161 outputs an obtained image input from image obtaining portion 159 to output portion 163.

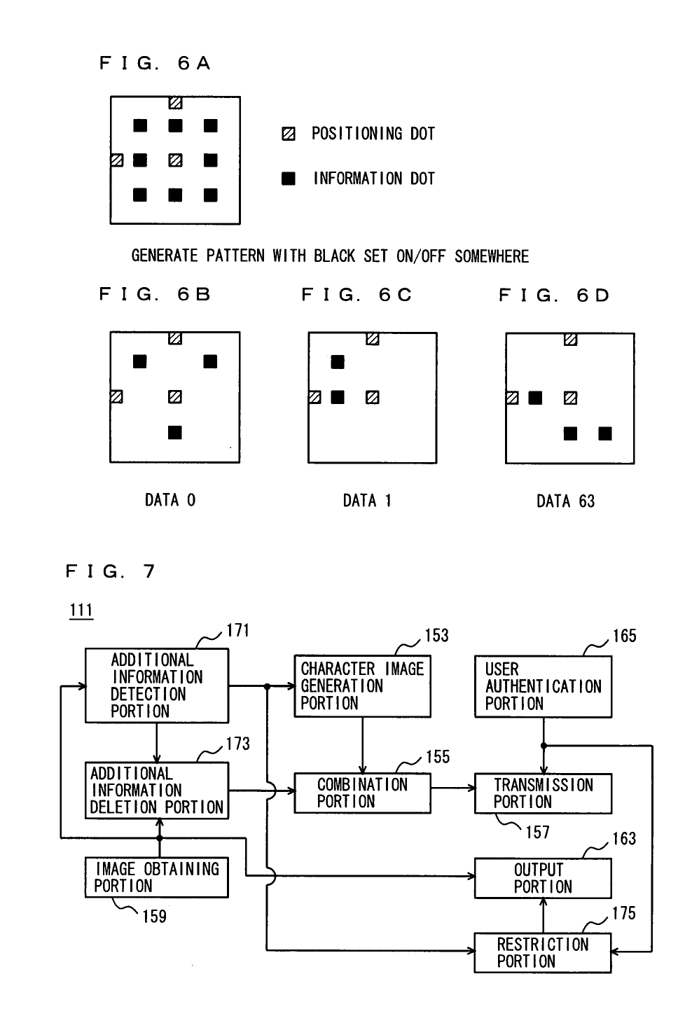

FIG. 6A-FIG. 6D are diagrams showing an example of dot pattern. Referring to FIG. 6A, a dot pattern includes three dots for positioning and eight dots for information. The presence/absence of eight dots for information defines 64 kinds of dot patterns, and 64 characters can be respectively allocated to 64 kinds of dot patterns. Here, the dots for positioning and the dots for information have different densities. Alternatively, colors or sizes may differ. FIG. 6B-FIG. 6D show an example of dot patterns in which data “0,” “1,” and “63” are allocated, respectively.

Returning to FIG. 4, output portion 163 outputs the obtained image or the embedding image input from embedding portion 161. The output destination of the obtained image or the embedding image depends on the process content input by the user to operation portion 115. In a case of a scan job or a data storage job, the obtained image or the embedding image is stored in HDD 116. In a case of a copy job, a BOX print job, a print job or a FAX reception job, the obtained image or the embedding image is output to image formation portion 30 to allow image formation portion 30 to form the obtained image or the embedding image on paper. In case of a FAX transmission job, the obtained image or the embedding image is output to facsimile portion 60 to allow facsimile portion 60 to transmit the obtained image or the embedding image according to a facsimile standard. In a case of a data transmission job, the obtained image or the embedding image is output to data communication control portion 117 to allow data communication control portion 117 to transmit the obtained image or the embedding image via FTP or SMB.

FIG. 7 is a second functional block diagram showing an overall function of CPU included in MFP. The functional block diagram shown in FIG. 7 shows the functions in the case where MFP 100 reads a document by image reading portion 20. The document read by image reading portion 20 includes the one in which an image having additional information embedded therein is formed and the one in which an image having no additional information embedded therein is formed. Referring to FIG. 7, the same functions as shown in FIG. 4 are denoted with the same reference characters. CPU 111 includes image obtaining portion 159, an additional information detection portion 171 detecting additional information from an obtained image obtained from image obtaining portion 159, an additional information deletion portion 173 for deleting additional information from an obtained image, character image generation portion 153, combination portion 155, user authentication portion 165, transmission portion 157, output portion 163, and a restriction portion 175 for restricting an output of an obtained image by output portion 163.

Image obtaining portion 159 obtains an obtained image output by image reading portion 20 reading an original document. Image obtaining portion 159 outputs an obtained image to additional information detection portion 171, additional information deletion portion 173 and output portion 163.

Additional information detection portion 171 detects additional information embedded in an obtained image input from image obtaining portion 159. If additional information is detected, the additional information is output to character image generation portion 153 and restriction portion 175.

Character image generation portion 153 generates an image of characters of the additional information input from additional information detection portion 171 and outputs a character image to combination portion 155. Combination portion 155 combines an image, from which additional information is deleted, input from additional information deletion portion 173, with a character image input from character image generation portion 153 to generate a combination image. Combination portion 155 outputs the combination image to transmission portion 157. User authentication portion 165 and transmission portion 157 are as described above and the description is not repeated here.

In server 200, a combination image formed by combining an image with an image of characters of additional information is stored when MFP 100 outputs an image having additional information embedded therein. In addition, the same image is also stored when MFP 100 reads an original document in which an image having additional information output earlier embedded therein is formed. Therefore, in the case where an image is output and in the case where an image is read by image reading portion 20, a history including the same image combined with a character image of additional information can be stored.

When additional information is input from additional information detection portion 171, restriction portion 175 restricts an output of an image by output portion 163 so that image formation portion 30 forms an image according to additional information. Specifically, in the case where the control code of additional information is “002,” output portion 163 is permitted to form an obtained image, if the user having the user ID input from user authentication portion 165 belongs to the department specified by the department code included in the parameter of the additional information, while output portion 163 is not permitted to form an obtained image, if the user does not belong to the department specified by the department code included in the parameter of additional information.

In the case where the control code of additional information is “003,” output portion 163 is permitted to form an obtained image, if the user ID input from user authentication portion 165 agrees with the user ID included in the parameter of the additional information, while output portion 163 is not permitted to form an obtained image, if the user ID does not agree with the user ID included in the parameter of the additional information.

In the case where the control code of additional information is “004,” the password input to operation portion 115 is accepted, and if the input password is identical to the password included in the additional information, output portion 163 is permitted to form an obtained image. However, if the input password does not agree with the password included in the parameter of the additional information, output portion 163 is not permitted to form an obtained image.

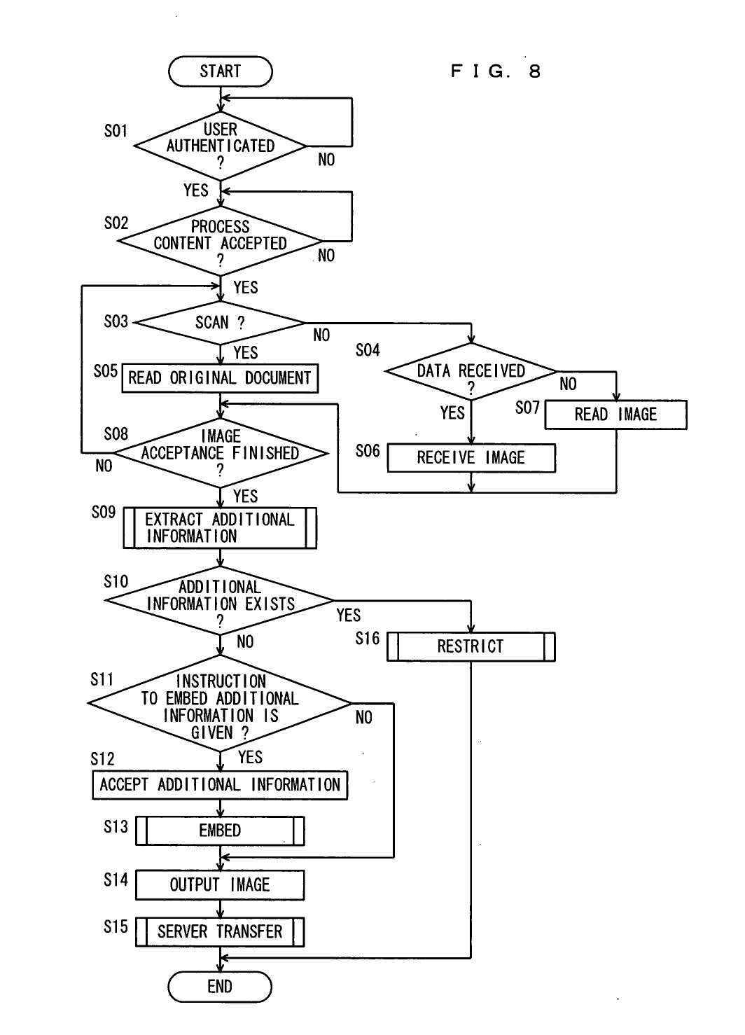

FIG. 8 is a flowchart showing an exemplary flow of an output process. The output process is a process executed by CPU 111 by CPU 111 executing an image processing program. Referring to FIG. 8, CPU 111 determines whether or not a user is authenticated (step S01). The process enters a standby state until a user is authenticated (NO in step S01), and if a user is authenticated, the process proceeds to step S02. When a user inputs the user ID and password to operation portion 115, CPU 111 compares the input user ID and password with a pair of user ID and password of the user data stored beforehand. If the input pair of user ID and password exists in the user data stored beforehand, the user is authenticated, and if there is no match, the user is not authenticated. It is noted that any given user whose user ID and password are not stored beforehand may be authenticated as a guest user.

In step S02, a process content is accepted. An inputting operation by the user to operation portion 115 is accepted. The process content includes here a scan job, a copy job, a FAX transmission job, a FAX reception job, a data transmission job, a BOX print job, a print job, and a data storage job. When the user inputs the process content of each of a scan job, a copy job, a FAX transmission job, a data transmission job, and a BOX print job, the process content input to operation portion 115 is accepted from operation portion 115. In addition, when data communication control portion 117 receives a print job or a data storage job, the process content included in the print job or the data storage job is accepted. When facsimile portion 60 receives a FAX reception job, the process content included in the FAX reception job is accepted.

Here, when a print job, a data storage job or a FAX reception job is received, the job includes a user ID and a password together with an image, and the user ID and the password included in the job are used for authentication in step S01.

In step S03, it is determined whether the process content accepted in step S02 includes a scan process of reading an original document. If the process content includes a scan process, the process proceeds to step S05, and if not, the process proceeds to step S04. The process content including a scan process is a scan job, a copy job, or a data transmission job or a FAX transmission job including the process content specifying reading of an original document.

In step S04, it is determined whether or not the process content includes a data reception process. If the process content includes a data reception process, the process proceeds to step S06, and if not, the process proceeds to step S07. The process content including a data reception process is a print job, a FAX reception job or a data storage job. The process proceeds to step S07 in the case of a data transmission job, a BOX print job, or a FAX transmission job which specifies an image to be processed, where an image stored in HDD 116 is specified by the user.

In step S05, image reading portion 20 is allowed to read an original document, and an image output by image reading portion 20 is accepted. The process then proceeds to step S08. In step S06, an image received by data communication control portion 117 or facsimile portion 60 is accepted, and the process then proceeds to step S08. In step S07, an image is read from HDD 116, and the process then proceeds to step S09.

In step S08, it is determined whether or not acceptance of an image is finished. If acceptance of an image is finished, the process proceeds to step S09. However, if not finished, the process returns to step S03.

In step S09, an additional information extraction process for extracting additional information from the accepted obtained image is executed. The additional information extraction process will be described later. Then, it is determined whether or not additional information is extracted (step S10), and if additional information is extracted, the process proceeds to step S16. If not extracted, the process proceeds to step S11. In step S16, a restriction process is executed, and the process then ends. The restriction process will be described later.

In step S11, it is determined whether or not an instruction to embed additional information is accepted. If an instruction to embed additional information is accepted, the process proceeds to step S12, and if not, the process proceeds to step S14. The instruction to embed additional information is input to operation portion 115 by the user and thus accepted from operation portion 115. For example, a button for inputting an instruction to embed additional information is prepared on operation portion 115, so that an instruction to embed additional information is accepted when the button is pressed. In the cases of a print job, a FAX reception job and a data storage job, if additional information is included in the received print job, FAX reception job or data storage job, it is determined that an instruction to embed additional information is given.

In step S12, additional information is accepted. When the user inputs additional information to operation portion 115, the input additional information is accepted from operation portion 115. Here, in the case of a print job, a FAX reception job or a data storage job, the instruction to embed additional information is accepted at the time when such a job is received. Then, an embedding process is executed for embedding the accepted additional information in the obtained image accepted in step S05, step S06 or step S07. The process then proceeds to step S14. The embedding process will be described later.

In step S14, the obtained image or the embedding image having additional information embedded therein is output. The outputting manner is defined by the process content accepted in step S02. If the process content is a scan job or a data storage job, the obtained image or the embedding image is stored in HDD 116. If the process content is a copy job, a BOX print job, a print job or a FAX reception job, the obtained image or the embedding image is output to image formation portion 30 to allow image formation portion 30 to form the obtained image or the embedding image on paper. If the process content is a FAX transmission job, the obtained image or the embedding image is output to facsimile portion 60 to allow facsimile portion 60 to transmit the obtained image according to a facsimile standard. If the process content is a data transmission job, the obtained image or the embedding image is output to data communication control portion 117 to allow data communication control portion 117 to transmit the obtained image via FTP or SMB.

The image data to be output is an embedding image in the case where the process proceeds from step S13, while it is an obtained image accepted in step S05, step S06 or step S07 in the case where the process proceeds from step S16.

In step S15, a server transfer process is executed. The server transfer process, which will be described later, is a process of generating a combination image based on the obtained image accepted in step S05, step S06 or step S07 and additional information and transmitting the combination image to server 200.

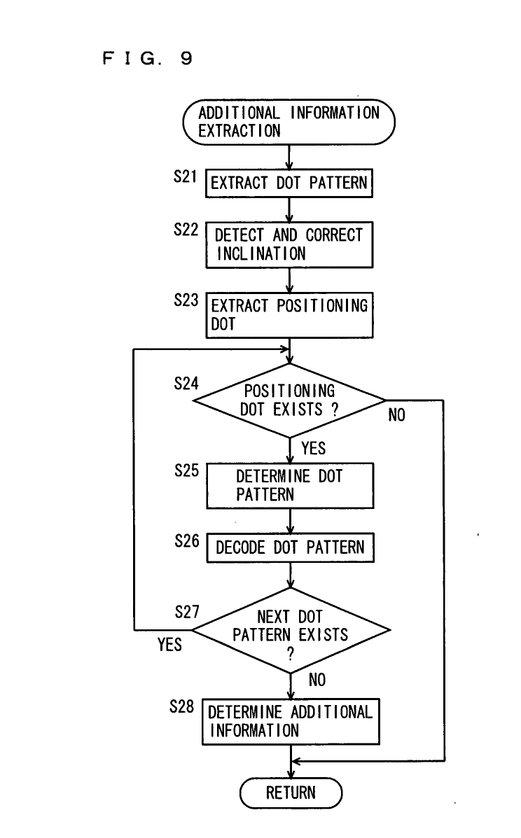

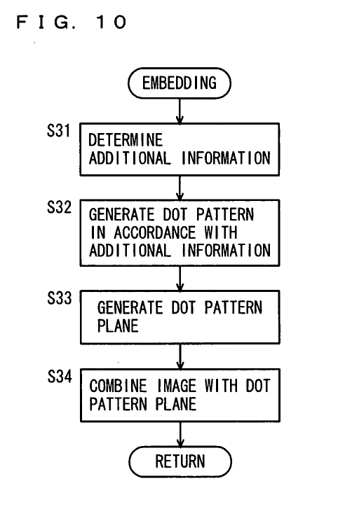

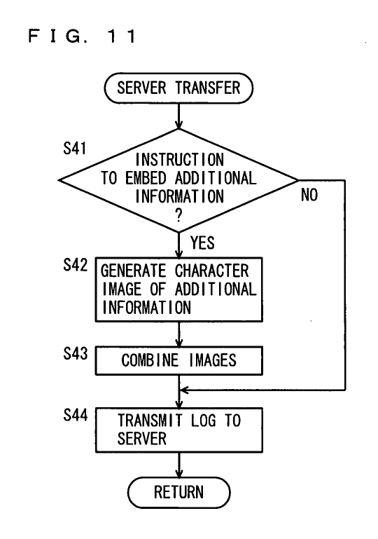

FIG. 9 is a flowchart showing an exemplary flow of the additional information extraction process. The additional information extraction process is a process executed in step S09 in FIG. 8. Referring to FIG. 9, CPU 111 extracts a dot pattern from an obtained image (step S21). A region where a plurality of dots are arranged in the obtained image is extracted as a dot pattern.

Then, the inclination of the obtained image is detected and corrected (step S22). A conventionally known technique can be used for the inclination detection. For example, a straight line or a region surrounding a character string included in the image data is detected, and the obtained image is then rotated so that the line or the region lies horizontally or vertically.

Next, a positioning dot is extracted (step S23). As shown in FIG. 6A, one pattern image includes three positioning dots. A positioning dot differs from an information dot in density. Therefore, a positioning dot can be extracted by extracting a dot having a prescribed density from the dot pattern extracted in step S21.

In step S24, it is determined whether or not a positioning dot is extracted. If the positioning dot is extracted, the process proceeds to step S25, and if not, the process returns to the image processing. This is because, if no positioning dot is extracted, there exists no dot pattern and additional information is not embedded.

In step S25, a dot pattern is determined. Specifically, a dot pattern is determined based on the arrangement of information dots present in the periphery of the positioning dot extracted in step S23. Then, the determined dot pattern is decoded (step S26). Specifically, the determined dot pattern is converted into a character assigned thereto beforehand. Then, it is determined whether or not the dot pattern to be processed exists (step S27). If a dot pattern to be processed exists, the process returns to step S24, and if not exist, the process proceeds to step S28.

In step S28, the character string in which the characters obtained by decoding the dot pattern are arranged is determined as additional information, and the process then returns to the output process.

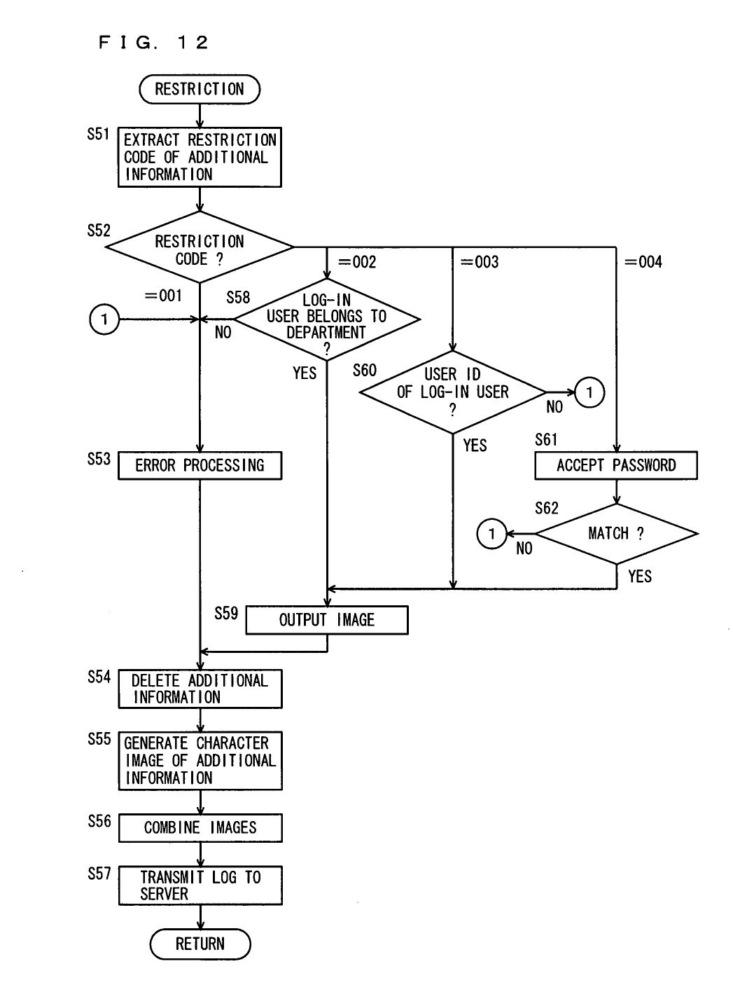

FIG. 10 is a flowchart showing an exemplary flow of the embedding process. The embedding process is a process executed in step S13 in FIG. 8. Referring to FIG. 10, CPU 111 determines additional information. The additional information accepted in step S12 of the output process shown in FIG. 8 is determined (step S31). More specifically, as shown in FIG. 5, a control code and a parameter of the additional information are determined.

In the next step S32, a dot pattern in accordance with the additional information is generated. The additional information is constituted with a control code and a parameter, which are represented by characters. Predetermined dot patterns are generated corresponding to the characters.

Next, a dot pattern plane is generated. A dot pattern plane is an image in which images of the dot patterns generated in step S32 are arranged. In other words, a dot pattern plane is a watermark image.

Then, an embedding image is generated by combining the obtained image accepted in step S05, step S06 or step S07 in FIG. 8 with the dot pattern plane generated in step S33 (step S34). Thereafter, the process returns to the output process.

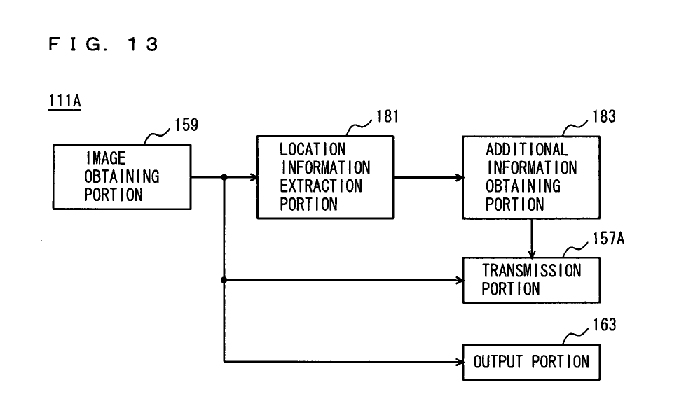

FIG. 11 is a flowchart showing an exemplary flow of the server transfer process. The server transfer process is a process executed in step S15 in FIG. 8. Referring to FIG. 11, CPU 111 determines whether or not an instruction to embed additional information is accepted (step S41). If an instruction to embed additional information is accepted in step S11 in FIG. 8, it is determined that an instruction to embed additional information is accepted. If an instruction to embed additional information is accepted, the process proceeds to step S42, and if not, the process proceeds to step S44.

In step S42, an image of characters of the additional information accepted in step S12 in FIG. 8 is generated. MFP 100 stores font images respectively corresponding to a plurality of characters. A character image is formed by arranging the font images respectively corresponding to the characters of the character string included in the additional information, in the arrangement order of the character string included in the additional information.

Then, a combination image is formed by combining the obtained image accepted in step S05, step S06 or step S07 in FIG. 8 with the character image generated in step S42. Thus, the additional information and the obtained image are integrated since the character image representing the additional information by characters is combined with the obtained image.

In step S44, a log is transmitted to server 200. A log includes an obtained image or a combination image, a user ID, apparatus identification information for identifying MFP 100, a date and time at that time, and a process content. The log includes a combination image in the case where the process proceeds from step S43 and includes an obtained image in the case where the process proceeds from step S41. The user ID is the user ID authenticated in step S01 in FIG. 8. The apparatus identification information is, for example, a name, an IP address or an MAC address assigned to MFP 100. The process content is the process content accepted in step S02. Therefore, a history is stored in server 200 indicating when, by whom, on which image and which process is performed. Furthermore, in the case where additional information is added to an obtained image, the character image of the additional information is combined, and therefore the additional information is stored integrally with the obtained image in server 200.

In the present embodiment, a combination image formed by combining a character image of additional information with an obtained image is transmitted to server 200. However, an obtained image and additional information may be incorporated separately as electronic data in a log to be transmitted to server 200, without combining additional information with an obtained image. In this case, the log stored in server 200 includes an obtained image and additional information as electronic data, in place of a combination image.

FIG. 12 is a flowchart showing an exemplary flow of the restriction process. The restriction process is a process executed in step S16 in FIG. 8. Referring to FIG. 12, CPU 111 extracts a restriction code from the additional information extracted from image data (step S51). Specifically, a restriction code is extracted from the additional information extracted in the additional information extraction process executed in step S09 in FIG. 8.

Then, the process branches depending on the extracted restriction code (step S52). In other words, the contents to be restricted are varied depending on the restriction code. If the restriction code is “001,” the process proceeds to step S53. If the restriction code is “002,” the process proceeds to step S54. If the restriction code is “003,” the process proceeds to step S56. If the restriction code is “004,” the process proceeds to step S57.

In the case where the process proceeds to step S53, the restriction code is “001” where copying is prohibited. Therefore, in step S53, an error process is executed. For example, a message indicating copying is prohibited appears on display portion 114 in order to notify the user that copying is prohibited.

In step S54, the additional information is deleted from the obtained image. Specifically, the dot pattern extracted from the obtained image in the additional information extraction process shown in FIG. 9 is deleted. Then, an image of characters of the additional information is generated (step S55). A character image is generated by arranging font images corresponding to the respective characters of the character string included in the additional information, in the arrangement order of the character string included in the additional information.

Then, in step S56, a combination image is generated by combining the obtained image, from which the additional information has been deleted in step S54, with the character image generated in step S55. Thus, the additional information and the obtained image can be integrated since the character image representing the additional information by characters is combined with the obtained image.

In step S57, a log is transmitted to server 200. A log includes a combination image, a user ID, apparatus identification information for identifying MFP 100, a date and time at that time, and a process content. Therefore, a history is stored in server 200 indicating when, by whom, on which image, which process is performed. Furthermore, since a combination image is an image formed by combining an obtained image with a character image of additional information, the additional information and the obtained image are integrally stored in server 200.

On the other hand, in step S58, it is determined whether or not the log-in user belongs to a department permitted to copy. The log-in user is a user who uses MFP 100 and is authenticated in step S01 in FIG. 8. The department permitted to copy is a department specified by a department code included in the parameter of additional information. MFP 100 stores a department table beforehand in which a department code is associated with the user ID of a user belonging to the department specified by the department code. It is determined whether or not the user ID of the log-in user is associated with the department code included in the additional information parameter by the department table. If associated, the process proceeds to step S59, and if not, the process proceeds to step S53. In the case where the process proceeds to step S53, printing of the obtained image is prohibited. In other words, the obtained image is printed on condition that the log-in user belongs to the department specified by the department code included in the parameter of the additional information.

In step S59, similar to step S14 in FIG. 8, the obtained image is output, and the process then proceeds to step S54.

In step S60, it is determined whether or not the log-in user is a user who is permitted to copy. If the log-in user is permitted to copy, the process proceeds to step S59, and if not, the process proceeds to step S53. In the case where the process proceeds to step S53, printing of the obtained image is prohibited. The user permitted to copy is the user specified by the user ID included in the parameter of the additional information. It is determined whether or not the user ID of the log-in user agrees with the user ID included in the parameter of the additional information. If both agree, the process proceeds to step S59, and if not, the process proceeds to step S53. In other words, image data is printed on condition that the user having the user ID included in the parameter of the additional information is a log-in user.

In step S61, an input of a password is accepted. A message prompting for an input of a password appears on display portion 114, and the password input to operation portion 115 by the user is accepted. Then, it is determined whether or not the accepted password agrees with the password included in the parameter of the additional information (step S62). If agree, the process proceeds to step S59, and if not agree, the process proceeds to step S53. In the case where the process proceeds to step S53, printing of the obtained image is prohibited. In other words, image data is printed on condition that a password identical to the password included in the parameter of additional information is input.

Therefore, a combination image formed by combining the character image of additional information with an obtained image having the additional information deleted therefrom is received in server 200, so that the combination image is stored in server 200. In addition, the additional information can be extracted later from the combination image. Therefore, server 200 compares a received combination image with a combination image included in a log stored in server 200 as a result of execution of step S15 in FIG. 8 in the past, whereby the log including the same combination image can be specified.

In particular, even if a combination image stored as a log is reduced or inversely compressed in order to reduce the amount of data in server 200, the character image of the additional information included in a combination image can be stored as a log reliably. Therefore, additional information can be traced reliably.

<Modification>

In the foregoing embodiment, additional information is embedded as a digital watermark in an obtained image, by way of example. In a modification, an obtained image includes location information on the network of additional information, for example, URL (Uniform Resource Locator). URL included in an obtained image may be characters or a two-dimensional code such as a QR code (Quick Response Code). In the following, a different point from the foregoing embodiment will mainly be described.

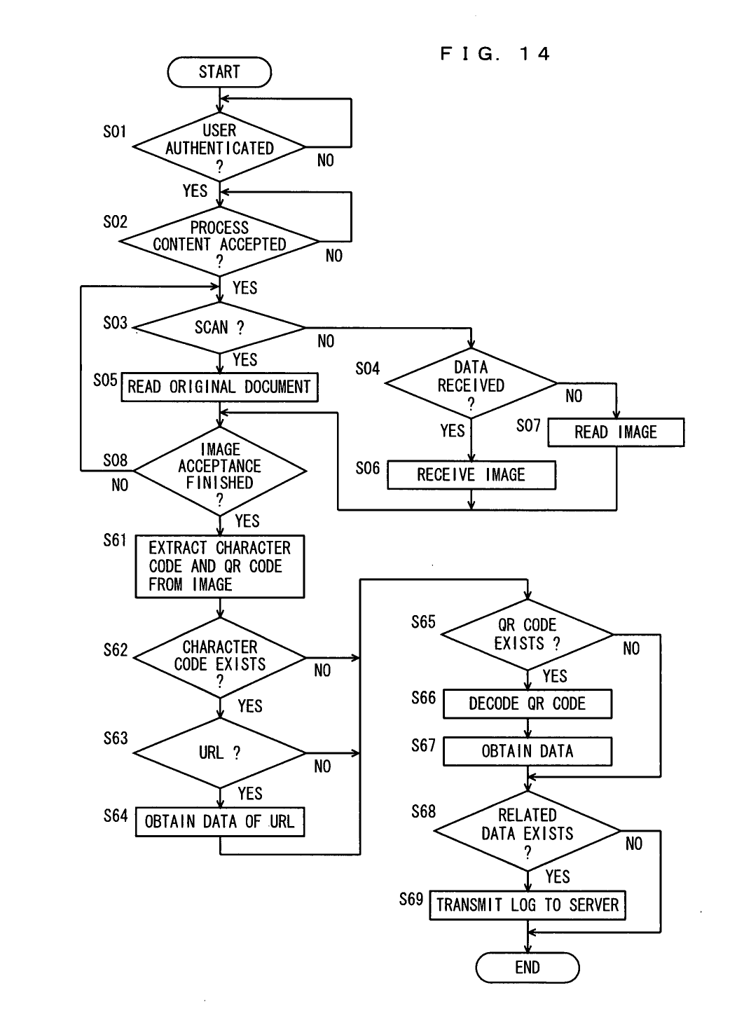

FIG. 13 is a functional block diagram showing an overall function of CPU included in MFP in the modification. A CPU 111A included in MFP 100 in the modification includes image obtaining portion 159, a location information extraction portion 181 for extracting location information from an obtained image obtained by image obtaining portion 159, an additional information obtaining portion 183 for obtaining additional information specified by the location information, a transmission portion 157A, and output portion 163.

Location information extraction portion 181 accepts an obtained image from image obtaining portion 159. Location information extraction portion 181 extracts location information from the obtained image. Specifically, a character string or a two-dimensional code of URL is extracted from the obtained image. If a character string of URL is extracted, the character string of URL is output to additional information obtaining portion 183. If a two-dimensional code such as a QR code is extracted, the QR code is decoded, and if the character string is URL, the character string of URL is output to additional information obtaining portion 183. If the character string obtained by decoding the QR code is not URL, it is ignored.

Additional information obtaining portion 183 obtains additional information specified by URL input from location information extraction portion 181. Here, the additional information specified by URL is referred to as related data. Specifically, the location on the network as specified by URL is at MFP 100, related data specified by URL is read from HDD 116, and if not at MFP 100, a download request is transmitted to an apparatus specified by URL through data communication control portion 117 so that related data is downloaded from the apparatus. When a plurality of URLs are input from location information extraction portion 181, additional information obtaining portion 183 obtains a plurality of related data specified by a plurality of URLs. Additional information obtaining portion 183 outputs the obtained related data to transmission portion 157A.

Transmission portion 157A receives an obtained image from image obtaining portion 159 and receives related data from additional information obtaining portion 183. Transmission portion 157A transmits a log in which the image data and the related data are associated with each other, to server 200. The log includes image data, related data, a user ID, a process content, and a date and time.

FIG. 14 is a flowchart showing a flow of an output process in the modification. The output process in the modification is a process executed by CPU 111A by CPU 111A executing an image processing program. Referring to FIG. 14, the processes of step S01-step 10 in the image processing shown in FIG. 8 are the same. Therefore, the description will not be repeated here.

In step S61, a character code and a QR code are extracted from the obtained image. The character code is extracted by extracting an image of characters from the obtained image and performing character recognition. Then, it is determined whether or not a character code is extracted (step S62). If a character code is extracted, the process proceeds to step S63, and if not, the process proceeds to step S65.

In step S63, it is determined whether or not the character code is URL. For example, if the character code includes “http://,” it is determined as URL. If the character code is URL, the process proceeds to step S64, and if not, the process proceeds to step S65. In step S64, related data specified by URL is obtained, and the process then proceeds to step S65. If the location on the network as specified by URL is at MFP 100, related data specified by URL is read from HDD 116. If not at MFP 100, a download request is transmitted to an apparatus specified by URL through data communication control portion 117 so that related data is downloaded from the apparatus.

In step S65, it is determined whether or not a QR code exists in the image data. It is determined that a QR code exists if a QR code is extracted from the image data in step S61. If there exists a QR code, the process proceeds to step S66, and if not exist, the process proceeds to step S68. In step S66, the QR code is decoded. Then, related data specified by the decoded URL is obtained (step S67), and the process then proceeds to step S68. If the location on the network as specified by URL is at MFP 100, related data specified by URL is read from HDD 116. If not at MFP 100, a download request is transmitted to an apparatus specified by URL through data communication control portion 117 so that related data is downloaded from the apparatus.

In step S68, it is determined whether or not related data exists. It is determined whether or not related data is obtained in step S64 or step S67. If related data exists, the process proceeds to step S69, and if not, the process ends. In step S64, a log is transmitted to server 200. The log includes an obtained image, related data, a user ID, a process content, and a date and time. In server 200, upon reception of a log, the log is stored in a storage device such as HDD. Since the log includes an obtained image and related data, the related data can be specified from the log even after the related data specified by URL included in the obtained image is deleted.

As described above, when additional information related to the obtained image is obtained, MFP 100 in the present embodiment generates a combination image formed by embedding the additional information in the obtained image and outputs the combination image, and also transmits the obtained image and the additional information to the sever. Therefore, an obtained image and additional information can be stored in a server reliably, and the history of an obtained image being output can be traced.

Furthermore, MFP 100 in the modification outputs an obtained image to the outside, and in addition, when location information is extracted from the obtained image, MFP 100 obtains related data stored at the location specified by the location information and transmits the related data together with the obtained image to server 200. Therefore, obtained image data and related data can be stored in server 200 reliably, and the history of the obtained image and the related data being output can be traced.

Although MFP 100 has been described as an example of image formation apparatus in the foregoing embodiment, it is needless to say that the present invention can be understood as an image processing method for executing the output process shown in FIG. 8-Fig. 12 or FIG. 14 or an image processing program for causing a computer to execute the image processing method.

In addition, although an output history is stored in server 200 in the foregoing embodiment, an output history may be stored in a storage device such as HDD 116 of MFP 100.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus comprising:
an image obtaining portion to obtain an image;
an additional information obtaining portion to obtain additional information related to said obtained image;
an output image generation portion to generate an output image formed by adding said obtained additional information to said obtained image;
an output portion to output said obtained image, if said additional information is not obtained, and to output said generated output image, if said additional information is obtained; and
a history storage portion to store a history of said obtained image being output, wherein
said history storage portion stores said additional information as a history together with said obtained image, if said additional information is obtained, and stores said obtained image as a history, if said additional information is not obtained.

2. The image processing apparatus according to claim 1, wherein said history storage portion includes a transmission portion to transmit said history to a server in order to store said history in a storage device included in said server.

3. The image processing apparatus according to claim 1, wherein said history storage portion includes a combination image generation portion to generate, if said additional information is obtained, a combination image formed by combining an image formed of a character of said obtained additional information with said obtained image, to store said generated combination image.

4. The image processing apparatus according to claim 1, wherein said output image generation portion includes
a conversion portion to convert said additional information into a dot pattern formed of a predetermined plurality of dots, and
a combination portion to combine said converted dot pattern with said obtained image.

5. The image processing apparatus according to claim 1, further comprising:
an image reading portion to read an image formed in a recording medium to output a read image;
an additional information detection portion to detect additional information from the image obtained by said image obtaining portion; and
an additional information deletion portion to delete said additional information from said obtained image, if said additional information is detected, wherein
said image obtaining portion obtains said read image output by said image reading portion, and
if said additional information is detected by said additional information detection portion, said history storage portion stores said detected additional information as a history together with an image formed by deleting said additional information from said read image.

6. The image processing apparatus according to claim 1, further comprising:
an additional information detection portion to detect said additional information from said obtained image; and
a restriction portion to restrict, if said additional information is detected, an output of said obtained image by said output portion according to said detected additional information.

7. An image processing apparatus comprising:
an image obtaining portion to obtain an image;
an output portion to output said obtained image;
a location information extraction portion to extract location information indicating a location on a network from said obtained image;
an additional information obtaining portion to obtain related data stored at a location specified by said extracted location information; and
a history storage portion to store a history of said obtained image being output, wherein
if said related data is obtained from said additional information obtaining portion, said history storage portion stores said obtained related data together with said obtained image.

8. An image processing method comprising the steps of:
obtaining an image;
obtaining additional information related to said obtained image;
generating an output image formed by adding said obtained additional information to said obtained image;
outputting said obtained image, if said additional information is not obtained, and outputting said generated output image, if said additional information is obtained; and
storing said additional information as a history together with said obtained image, if said additional information is obtained, and storing said obtained image as a history, if said additional information is not obtained.

9. The image processing method according to claim 8, wherein said storing step includes the step of transmitting said history to a server in order to store said history in a storage device included in said server.

10. The image processing method according to claim 8, wherein, if said additional information is obtained, said storing step includes the steps of
generating a combination image formed by combining an image of a character of said obtained additional information with said obtained image, and
storing said generated combination image.

11. The image processing method according to claim 8, wherein said step of generating an output image includes the steps of
converting said additional information into a dot pattern formed of a predetermined plurality of dots, and
combining said converted dot pattern with said obtained image.

12. The image processing method according to claim 8, wherein said step of obtaining an image includes the step of reading an image formed in a recording medium to output a read image, the method further comprising the steps of:
detecting additional information from said obtained read image;
if said additional information is detected, deleting said additional information from said obtained read image; and
if said additional information is detected, storing said detected additional information as a history together with an image formed by deleting said additional information from said read image, and if said additional information is not detected, storing said obtained read image.

13. The image processing method according to claim 8, further comprising the steps of:
detecting said additional information from said obtained image; and
if said additional information is detected, restricting an output of said obtained image according to said detected additional information.

14. An image processing method comprising the steps of:
obtaining an image;
outputting said obtained image;
extracting location information indicating a location on a network from said obtained image;
obtaining related data stored at a location specified by said extracted location information; and
if said related data is not obtained, storing said obtained image, and, if said related data is obtained, storing said obtained related data together with said obtained image.

15. An image processing program embodied on a computer readable medium for causing a computer to execute processing including the steps of:
obtaining an image;
obtaining additional information related to said obtained image;
generating an output image formed by adding said obtained additional information to said obtained image;
outputting said obtained image, if said additional information is not obtained, and outputting said generated output image, if said additional information is obtained; and
storing said additional information as a history together with said obtained image, if said additional information is obtained, and storing said obtained image as a history, if said additional information is not obtained.

16. The image processing program according to claim 15, wherein said storing step includes the step of transmitting said history to a server in order to store said history in a storage device included in said server.

17. The image processing program according to claim 15, wherein, if said additional information is obtained, said storing step includes the steps of
generating a combination image formed by combining an image of a character of said obtained additional information with said obtained image, and
storing said generated combination image.

18. The image processing program according to claim 15, wherein said step of generating an output image includes the steps of
converting said additional information into a dot pattern formed of a predetermined plurality of dots, and
combining said converted dot pattern with said obtained image.

19. The image processing program according to claim 15, wherein said step of obtaining an image includes the step of reading an image formed in a recording medium to output a read image, the processing further including the steps of:
detecting additional information from said obtained read image;
if said additional information is detected, deleting said additional information from said obtained read image; and
if said additional information is detected, storing said detected additional information as a history together with an image formed by deleting said additional information from said read image, and if said additional information is not detected, storing said obtained read image.

20. The image processing program according to claim 15, the processing further including the steps of:
detecting said additional information from said obtained image; and
if said additional information is detected, restricting an output of said obtained image according to said detected additional information.

21. An image processing program embodied on a computer readable medium for causing a computer to execute processing including the steps of:
obtaining an image;
outputting said obtained image;
extracting location information indicating a location on a network from said obtained image;
obtaining related data stored at a location specified by said extracted location information; and
if said related data is not obtained, storing said obtained image, and, if said related data is obtained, storing said obtained related data together with said obtained image.
